(19) United States
(12) Patent Application Publication
(10) Pub. No.: US 2009/0064263 A1
(43) Pub. Date: Mar. 5, 2009

(54) BROADCAST-RECEIVING APPARATUS AND METHOD OF OUTPUTTING DATA BY A BROADCAST-RECEIVING APPARATUS

(75) Inventor: Hwa-Kyung Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/118,041

(22) Filed: May 9, 2008

(30) Foreign Application Priority Data
Sep. 5, 2007 (KR) 10-2007-0090104

(51) Int. Cl. H04N 7/173

(52) U.S. Cl. 725/131

(57) ABSTRACT

There is provided a broadcast-receiving apparatus and a method of outputting data by a broadcast-receiving apparatus capable of outputting media content and real-time broadcasting data at the same time. According to an aspect of the present invention, there is provided a broadcast-receiving apparatus, including a receiving unit which receives a data broadcasting signal through a data broadcasting channel, an extracting unit which extracts data from the received data broadcasting signal, and a merging unit which merges the extracted data with media content that is being output.

### CROSS REFERENCE TO RELATED APPLICATION

This application claims priority from Korean Patent Application No. 10-2007-0090104 filed on Sep. 5, 2007 in the Korean Intellectual Property Office, the disclosure of which is incorporated herein by reference in its entirety.

### BACKGROUND OF THE INVENTION

1. Field of the Invention

Methods and apparatuses consistent with the present invention relate to receiving broadcast signals, and, more particularly, to a broadcast-receiving apparatus and a method of outputting data by a broadcast-receiving apparatus, which is capable of outputting media content and real-time broadcasting data at the same time.

2. Description of the Related Art

As digital TV transmission becomes more popular, digital broadcasting stations have been focusing more on the various functions of digital broadcasting, particularly, data broadcasting. In data broadcasting, various data as well as audio and video signals are transmitted using a data broadcast specification that is defined by the ATSC standard, which is a digital broadcast standard, and a terminal having a data-broadcast-receiving function (a TV or a set-top box) receives the data and displays the data on a screen in an appropriate format. In recent years, the ATSC has established a North American DTV data broadcast middleware standard called ACAP (advanced common application platform) that can make cable data broadcasting content compatible with terrestrial data broadcasting content. Therefore, manufacturers have made efforts to develop data-broadcast-receiving apparatuses suitable for the standard.

However, a function enabling the user to view real-time broadcasting data while watching moving-picture content or recorded content has not been developed.

As an example, a viewer may want to watch recorded drama content, and at the same time view broadcasting content of the election results being transmitted through a predetermined channel in real time. However, technology enabling this has not been proposed.

### SUMMARY OF THE INVENTION

An aspect of the present invention is to provide a broadcast-receiving apparatus and a method of outputting data by a broadcast-receiving apparatus capable of outputting media content and real-time broadcasting data at the same time.

However, the aspects, and features of the present invention are not restricted to the ones set forth herein. The above and other aspects, features and advantages of the present invention will become more apparent to one of ordinary skill in the art to which the present invention pertains by referencing a detailed description of the present invention given below.

According to an aspect of the present invention, there is provided a broadcast-receiving apparatus, comprising a receiving unit which receives a data broadcasting signal through a data broadcasting channel channel, an extracting unit which extracts data from the received data broadcasting signal, and a merging unit which merges the extracted data with media content that is being output.

According to another aspect of the present invention, there is provided a method of outputting data by a broadcast-receiving apparatus, comprising receiving a data broadcasting signal through a data broadcasting channel, extracting data from the received data broadcasting signal, and merging the extracted data with media content that is being output.

### BRIEF DESCRIPTION OF THE DRAWINGS

The above and other features and advantages of the present invention will become apparent by describing in detail exemplary embodiments thereof with reference to the attached drawings in which:

FIG. 1 is a block diagram illustrating the structure of a broadcast-receiving apparatus according to an exemplary embodiment of the present invention;

FIGS. 2 and 3 are diagrams illustrating an example of the display of data by the broadcast-receiving apparatus according to an exemplary embodiment of the present invention; and

FIG. 4 is a flowchart illustrating a method of outputting data by a broadcast-receiving apparatus according to an exemplary embodiment of the present invention.

### DETAILED DESCRIPTION OF EXEMPLARY EMBODIMENTS OF THE INVENTION

Features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

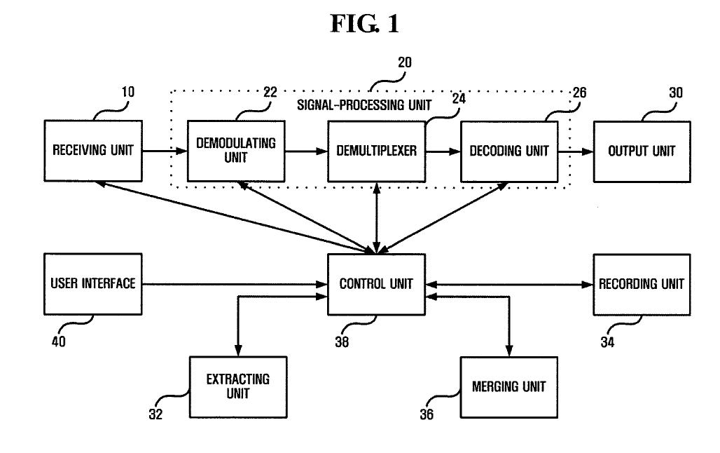

And each block of the flowchart illustrations may represent a module, segment, or portion of code, which comprises one or more executable instructions for implementing the specified logical function(s). It should also be noted that in some alternative implementations, the functions noted in the blocks may occur out of the order presented in the flowchart illustrations. For example, two blocks shown in succession may in fact be executed substantially concurrently or the blocks may sometimes be executed in the reverse order, depending upon the functionality involved. FIG. 1 is a block diagram illustrating the structure of a broadcast-receiving apparatus according to an exemplary embodiment of the present invention. The broadcast-receiving apparatus receives data broadcasting signals, and can be applied to, for example, digital televisions and set-top boxes.

As shown in FIG. 1, the broadcast-receiving apparatus according to the present exemplary embodiment includes a receiving unit 10 that receives broadcasting signals, a signal-processing unit 20 that processes the received broadcasting signals, an output unit 30 that outputs the processed broadcasting signals, an extracting unit 32 that extracts data from the broadcasting signals, a recording unit 34 that records the broadcasting signals output from the output unit 30, a merging unit 36 that merges the extracted data with media content that is currently being output from the output unit 30, a control unit 38 that controls these units, and a user interface 40 for user input.

The receiving unit 10 may include a tuner for receiving the broadcasting signals. The tuner is tuned to receive broadcasting signals of the channel selected by the user or a predetermined channel.

The signal-processing unit 20 may include a demodulating unit 22 that demodulates the received broadcasting signal, a demultiplexer 24 that demultiplexes the demodulated broadcasting signal, and a decoding unit 26 (for example, a video decoder or an audio decoder) that decodes the demultiplexed signal into the original signal.

A broadcasting signal stream demodulated by the demodulating unit 22 is output to the demultiplexer 24. The demultiplexer 24 demultiplexes an input broadcasting signal stream into audio, video, and data. That is, since the demodulated audio, video, and data are multiplexed in the form of a transport packet, the demultiplexer 24 can demultiplex the input broadcasting signal stream into audio, video, and data.

The data includes at least one of application data, data carousel data, and information that can be displayed on the screen as graphics or characters, but the present invention is not limited thereto. In a data carousel system, a data module is periodically transmitted through a DVB (digital video broadcasting) compatible broadcasting network, so that a receiver can receive data.

For example, the data may include applications that operate in real time with real time data and/or real time data that is provided during data broadcasting, such as news information, weather information, traffic information, home shopping information, stock information, and emergency news. However, the present invention is not limited thereto, and other data can be used. The audio signal is output from the demultiplexer 24 to an audio decoder. The audio decoder decodes a compressed audio signal into the original audio signal, and outputs the decoded signal to the output unit 30 (for example, a speaker). The video signal is output from the demultiplexer 24 to a video decoder. The video decoder decodes a compressed video signal into the original video signal and displays the decoded signal on the output unit 30 (for example, a screen).

The extracting unit 32 extracts data that is demultiplexed by the demultiplexer 24, to form content. That is, since the data is a data stream having a header portion (which includes, for example, information indicating the start of a signal and a packet ID number indicating information included in the next payload portion) and a payload portion (a pure data portion), the extracting unit 32 extracts a pure data component and groups components into one set of content (hereinafter, referred to “data content”).

Data content that is generated by the extracting unit 32 is displayed on the screen together with a video signal that is output from video decoder in real time, or they are output to the merging unit 36. The display of the data content and the video signal that is output from the video decoder in real time on the screen means the output of the data broadcasting signal from the output unit 30.

Meanwhile, data content output to the merging unit 36 is generated when the user inputs a data-extracting instruction. The input of the data-extracting instruction may include the input of information on a channel through which data is extracted. For example, when the user sets the channel for extracting data to channel No. 5, the extracting unit 32 extracts data from a broadcasting signal that is received through the channel No. 5 and forms content. In order to perform this operation, it is preferable to provide a user interface 40, such as a graphical user interface (GUI) and/or a remote controller for inputting the data-extracting instruction.

The above-mentioned structure enables a data broadcasting signal that is provided to the broadcast-receiving apparatus to be recorded by the recording processing unit 34. The recorded broadcasting signal is separated into video, audio, and data, and the separated components are stored in an internal or external storage medium. When the user requests to reproduce the recorded broadcasting signal, the control unit 38 controls the extracting unit to extract the broadcasting signal stored in the storage medium, and controls the decoding unit 26 to decode the extracted broadcasting signal. The decoded broadcasting signal is output to the output unit 30. The control unit 38 may reproduce moving picture content that is received through a network (for example, an Internet network) or stored in a storage medium, in addition to reproducing the recorded broadcasting signal. Hereinafter, the recorded broadcasting signal, and moving picture content that are received through the network or stored in the storage medium are commonly referred to as “reproducing content”.

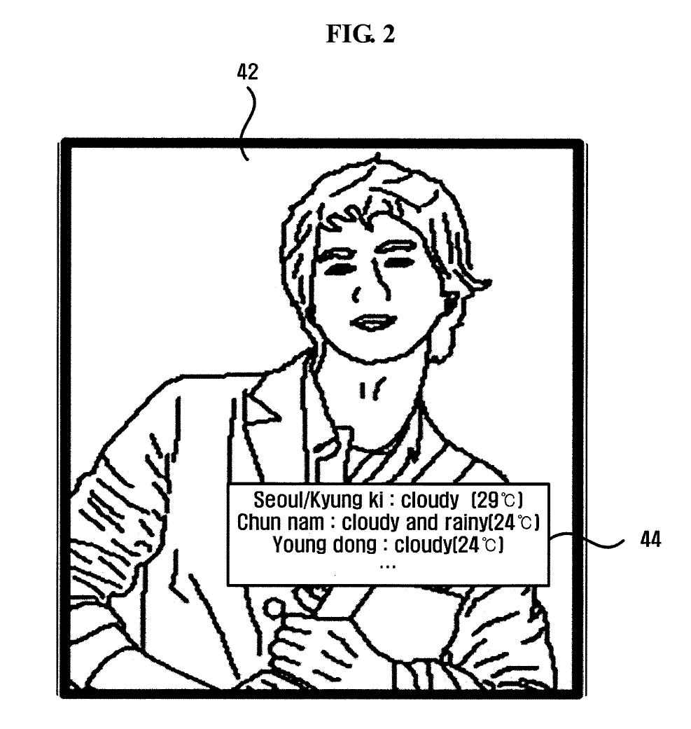

The merging unit 36 merges reproducing content and data content and outputs merged content. In this case, as shown in FIG. 2, it is preferable that data content 44 be displayed on reproducing content 42 in a PIP (picture-in-picture) so that the user can view both the reproducing content 42 and the data content 44.

FIG. 2 is a diagram illustrating the reproducing content 42 displayed as a main picture and the data content 44 displayed as a sub-picture. Alternatively, the data content 44 may be displayed as the main picture, and the reproducing content 42 may be displayed as the sub-picture. In addition, the display of the pictures for the content may be switched. That is, according to the input of the user, the picture for the data content 44 may be changed from the sub-picture to the main picture or from the main picture to the sub-picture. For example, when the user wants to display data content, which is a PIP, as the main picture while watching the reproducing content displayed as the main picture, the display of the data content can be changed from the sub-picture to the main picture.

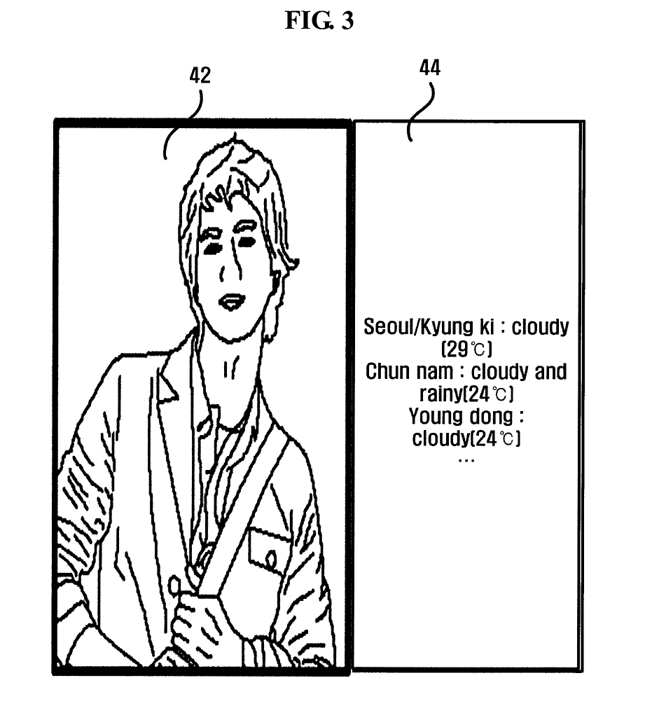

The display of the reproducing content and the data content is not limited to the PIP mode, but various display modes may be used. For example, as shown in FIG. 3, the screen may be divided in a predetermined direction (for example, a horizontal or vertical direction) at a predetermined ratio, and the reproducing content 42 and the data content 44 may be displayed on the divided screens.

Alternatively, only the reproducing content may be displayed after a predetermined time has elapsed, when a display mode in which data content are not displayed is selected, or after the display of the data content is completed.

In the present exemplary embodiment, the merging unit 36 merges the data content with the reproducing content, but the present invention is not limited thereto. For example, when the output unit 30 outputs broadcasting content through a predetermined channel in real time, the merging unit 36 extracts data content from broadcasting signals transmitted through a channel that is different from the channel, merges the extracted data content with the real-time broadcasting content, and outputs the merged content.

When the user inputs a channel that (s)he wants to watch, the control unit 38 controls the receiving unit 10 and the signal-processing unit 20 to receive broadcasting signals through the input channel. As described above, the data broadcasting signal is output to the output unit 30 together with the data content generated by the extracting unit 32.

When a recording instruction is input, the control unit 38 controls the recording processing unit 34 to process the broadcasting signal that is currently output to the output unit 30 and to store the processed signal in a storage medium.

When channel information having data to be extracted is input, the control unit 38 controls the receiving unit 10, the signal-processing unit 20, and the extracting unit 32 to extract data from broadcasting signals that are input through the channel to form content. Then, the control unit 38 controls the merging unit 36 to merge data content generated by the extracting unit 32 with reproducing content (or real-time broadcasting content) and to output the merged content.

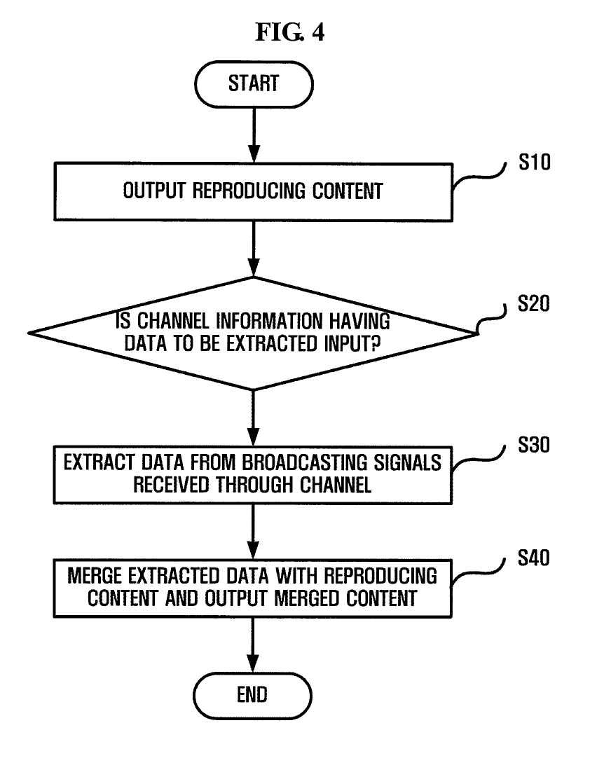

Next, a method of outputting data by the broadcast-receiving apparatus having the above-mentioned structure according to an exemplary embodiment of the present invention will be described below with reference to FIG. 4.

It is assumed that the output unit 30 outputs reproducing content.

When the user wants to see weather information while watching reproducing content (S10), the user inputs a data-extracting instruction. In this case, the user may input channel information having data to be extracted. For example, it is assumed that weather information is received through channel No. 10.

When the user inputs information on channel No. 10 as the channel information having data to be extracted (S20), the extracting unit 32 extracts data for weather information from broadcasting signals that are received through channel No. 10 to form content (S30).

Data content for weather information is output to the merging unit 36, and the merging unit 36 merges the data content for weather information with current reproducing content, and outputs the merged content to the output unit 30 (S40).

In this way, the user can see weather information while watching “reproducing content”.

The data content extracted by the extracting unit 32 may be stored in a storage unit such that the user can play back the data content later, if necessary.

As described above, the broadcast-receiving apparatus and the method of outputting data by the broadcast-receiving apparatus according to the exemplary embodiments of the present invention can output media content and real-time data broadcasting signals at the same time.

Although the present invention has been described in connection with the exemplary embodiments of the present invention with reference to the accompanying drawings, it will be apparent to those skilled in the art that various modifications and changes may be made thereto without departing from the scope and spirit of the invention. Therefore, it should be understood that the above exemplary embodiments are not limitative, but illustrative in all aspects.

What is claimed is:

1. A broadcast-receiving apparatus comprising:
a receiving unit which receives a data broadcasting signal through a data broadcasting channel;
an extracting unit which extracts data from the received data broadcasting signal; and
a merging unit which merges the extracted data with media content that is being output.

2. The broadcast-receiving apparatus of claim 1, wherein the media content includes at least one of recorded broadcasting signals, moving picture content that is received through a network or stored in a storage medium, and broadcasting signals that are received through a channel different from the data broadcasting channel.

3. The broadcast-receiving apparatus of claim 1, further comprising:
a user interface which receives input for determining the data broadcasting channel.

4. The broadcast-receiving apparatus of claim 1, wherein the extracted data includes at least one of data carousel data, application data, and information that can be displayed on a screen as one of graphics and characters.

5. The broadcast-receiving apparatus of claim 1, wherein the merging unit merges the extracted data and the media content in a picture in picture (PIP) mode.

6. The broadcast-receiving apparatus of claim 1, wherein the merging unit merges the extracted data and the media content by dividing an image of the media content being output in a predetermined direction at a predetermined ratio, and providing the media content in one division and the extracted data in another division.

7. The broadcast-receiving apparatus of claim 5, wherein a PIP position of the extracted data changes according to a user input.

8. The broadcast-receiving apparatus of claim 6, wherein a division position of the extracted data changes according to a user input.

9. The broadcast-receiving apparatus of claim 1, wherein the merging unit merges the extracted data with the media content only for a predetermined amount of time, when one of a display mode in which the extracted data is not displayed is selected, and the display of the extracted data is completed.

10. A method of outputting data by a broadcast-receiving apparatus, comprising:
receiving a data broadcasting signal through a data broadcasting channel;
extracting data from the received data broadcasting signal; and
merging the extracted data with media content that is being output.

11. The method of claim 10, wherein the media content includes at least one of recorded broadcasting signals, moving picture content that is received through a network or stored in a storage medium, and broadcasting signals that are received through a channel different from the data broadcasting channel.

12. The method of claim 10, further comprising:
determining the data broadcasting channel through a user interface,
wherein the data broadcasting signal is received through the determined data broadcasting channel.

13. The method of claim 10, wherein the data includes at least one of data carousel data, application data, and information that can be displayed on a screen as graphics or characters.

14. The method of claim 10, wherein the merging comprises merging the extracted data and the media content in a picture in picture (PIP) mode.

15. The method of claim 10, wherein the merging comprises merging the extracted data and the media content by dividing an image of the media content being output in a predetermined direction at a predetermined ratio, and providing the media content in one division and the extracted data in another division.

16. The method of claim 14, further comprising:
changing a PIP position of the extracted data according to a user input.

17. The method of claim 15, further comprising:
changing a division of the extracted data according to a user input.

18. The method of claim 10, further comprising:
merging the extracted data with the media content only for a predetermined amount of time, when one of a display mode in which the extracted data is not displayed is selected, and the display of the extracted data is completed.
